(19) United States
(12) Patent Application Publication
(10) Pub. No.: US 2019/0374970 A1
(43) Pub. Date: Dec. 12, 2019

(54) ENAMEL-COATING DEVICE AND METHOD FOR FIN TUBE

(71) Applicant: KOPEC CO.,LTD, Gimhae-si, Gyeongsangnam-do (KR)

(72) Inventor: Seong Ho SEO, Busan (KR)

(21) Appl. No.: 16/477,315

(22) PCT Filed: Dec. 22, 2017
(86) PCT No.: PCT/KR2017/015327

§ 371 Date: Jul. 11, 2019

(30) Foreign Application Priority Data
Jan. 11, 2017 (KR) 10-2017-0004363
Jan. 11, 2017 (KR) 10-2017-0004364
Jan. 11, 2017 (KR) 10-2017-0004366

(51) Int. Cl. B05C 3/132; C23D 5/04; C23D 9/06; C23D 1/02; B05C 9/14

(52) U.S. Cl. CPC B05C 3/132; C23D 5/04; B05C 9/14; C23D 1/02; C23D 9/06

(57) ABSTRACT

The present invention relates to an enamel coating device for a fin tube and its method and, more particularly, to an enamel coating device for a fin tube for efficiently coating a fin tube with enamel. The configuration of the present invention for achieving the objects provides an enamel coating device for a short fin tube that is not deformed at a high temperature, the device including: a conveying unit that conveys a fin tube having a hollow tube and a fin spirally formed on the outer side of the tubes; an applying unit that applies glaze powder to the fin tubes loaded by the conveying unit; and heating units that are disposed at both sides of the applying unit to heat the fin tubes, in which the glaze powder is pure frit.

### TECHNICAL FIELD

The present invention relates to an enamel coating device for a fin tube and its coating method and, more particularly, to an enamel coating device for a fin tube and its coating method for efficiently coating a fin tube with enamel.

### BACKGROUND ART

In general, fin tubes made of metal are usually used in a high-temperature and high-humidity environment, so they need to be coated for improving durability. Enamel coating, which is one of methods of such coating, has an advantage of high heat resistance and acid resistance, but has a disadvantage that the coating process is difficult because high-temperature firing and a large chamber are required.

Accordingly, methods for performing enamel coating while solving this problem have been studied in the related art. For example, an enamel coating method for a metal tube has been disclosed in Korean Patent No. 10-1074438 (hereafter, referred to as a prior art document). In detail, the prior art document discloses a technology of pre-processing a metal tube, coating the metal tube with enamel glaze, and then firing the metal tube.

However, additives such as clay and other oxides have to be necessarily added to prevent the liquid-state enamel glaze disclosed in the prior art document from flowing down when it is coated on a fin tube. Accordingly, when enamel glaze is coated on a fin tube, these additives deteriorates the acid resistance, so it may cause the problem that the fin tube easily corrodes in an environment with high possibility of corrosion such as a power plant. Further, the additives may roughen the surface of a fin tube coated with an enamel glaze.

Further, a brush is provided to uniformly apply enamel glaze in the prior art document, but with this configuration, it is only possible to uniformly apply liquid-state enamel glaze, but it is impossible to adjust the thickness of an enamel coating layer at specific portions. That is, there is a problem that it is impossible to protect portions having high possibility of corrosion by making an enamel coating layer thicker.

Further, a drying process is necessarily required to form a coating layer after liquid-state enamel glaze is applied in the related art, so it takes long time to produce a fin tube.

Further, rollers for conveying a fin tube are provided in the section where a fin tube is coated with enamel glaze and fired. Accordingly, a fin tube coated with enamel rubs with the rollers even before firing is finished. The enamel coating layer comes off a fin tube that has rubbed before firing is finished, so the outer surface of the fin tube increases in possibility of corrosion. Further, the operation time decreases, so an excessive cost is consumed for replacement and maintenance.

Enamel is moved for each process and then connected because pre-processing, glaze applying, drying, and firing are separated in the related art, but fin tubes are long for the characteristics of the products, so the processes should be continuous. Accordingly, there is a disadvantage in the related art that the facilities are large in size, the movement distances are long between the processes, and accordingly, there are many factors that should be managed for each process.

### CITATION LIST

### Patent Literature

[Patent Literature 1]
   Korean Patent No. 10-1074438

### SUMMARY OF INVENTION

### Technical Problem

In order to solve the problems, an object of the present invention is to provide an enamel coating device for a fin tube and its coating method for efficiently coating a fin tube with enamel.

The objects to implement in the present invention are not limited to the technical problems described above and other objects that are not stated herein will be clearly understood by those skilled in the art from the following specifications.

### Solution to Problem

The configuration of the present invention for achieving the objects provides an enamel coating device for a fin tube, the device including: a conveying unit that conveys a fin tube having a hollow tube and a fin spirally formed on the outer side of the tube; an applying unit that applies glaze powder to the fin tubes loaded by the conveying unit; and heating units that are disposed at both sides of the applying unit to heat the fin tubes, in which the glaze powder is pure frit.

In an embodiment of the present invention, the heating unit may include: a preheating unit disposed at a side of the applying unit and heating the fin tube loaded by the conveying unit; and a firing unit disposed at the other side of the applying unit and heating the fin tube applied with the glaze powder.

In an embodiment of the present invention, the applying unit and the preheating unit may be spaced by a predetermined first gap, the applying unit and the firing unit may be spaced by a predetermined second gap, and the first gap and the second gap may be different.

In an embodiment of the present invention, the first gap may be characterized by being 0.04 to 0.06 m, and the second gap may be 0.09 to 0.11 m.

In an embodiment of the present invention, the conveying unit may include: a feeder unit loading the fin tube into the preheating unit; and an unfeeder unit restoring the fin tube that has passed through the firing unit.

In an embodiment of the present invention, the feeder unit and the unfeeder unit may include: a plurality of rollers including pairs of a first wheel and a second wheel on which the fin tube is placed; a rotary shaft disposed to connect the first wheels through the center of the first wheels; and a motor providing rotational power to the rotary shaft, and the first wheels may move the fin tube forward and backward in accordance with the rotational direction of the rotary shaft by rotating in contact with the outer side of the fin.

In an embodiment of the present invention, the second wheels may rotatably support the fin tube and may extend in the forming direction of the fin spirally formed.

In an embodiment of the present invention, the gap between the roller disposed at the inlet of the preheating unit and the roller disposed at the outlet of the firing unit is between 1 m to 1.2 m so it is possible to prevent sagging of the fin tube 10 disposed at the heating unit 1200 and the applying unit 1300.

In an embodiment of the present invention, the rollers are provided such that the gap of adjacent pair is adjusted in correspondence to the diameter of the fin tube.

In an embodiment of the present invention, the feeder unit further includes a loader providing the fin tube onto the rollers, and the unfeeder unit further includes an unloader restoring the fin tube on the rollers.

The configuration of the present invention for achieving the objects provides a coating method using the enamel coating device for a fin tube, the method including: a) preheating the fin tube; b) applying the glaze powder to the preheated fin tube; and c) firing the fin tube applied with the glaze powder, in which the glaze powder is pure frit in the step b) applying of the glaze powder.

The configuration of the present invention for achieving the objects provides a high-frequency induction heating unit that includes: a preheating unit disposed at a side of an applying unit for applying glaze powder to the fin tube; and a firing unit disposed at the other side of the applying unit and heating the fin tube applied with the glaze powder, in which the preheating unit and the firing unit perform induction heating in accordance with movement of the fin tube in a high-frequency magnetic field.

In an embodiment of the present invention, the heating unit heats the fin tube at 800° C. to 860° C.

In an embodiment of the present invention, the preheating unit and the firing unit may include: a heating module generating a high-frequency magnetic field for induction heating in accordance with movement of the fin tube in the high-frequency magnetic field; and a heating chamber accommodating the heating module and forming a body.

In an embodiment of the present invention, the heating chamber may include: a first vertical frame disposed at a side of the fin tube and vertically extending from the ground; and first horizontal frames extending in parallel toward the upper portion and the lower portion of the fin tube from the upper end and the lower end of the first vertical frame.

In an embodiment of the present invention, the heating chamber may include: a second vertical frame disposed at a side of the fin tube and vertically extending from the ground; and second horizontal frames extending toward the upper portion and the lower portion of the fin tube from the upper end and the lower end of the second vertical frame and bending and extending with a curvature corresponding to the circumference of the fin tube in accordance with the size of the fin tube.

In an embodiment of the present invention, the heating chamber may be provided in a tube shape that can accommodate the fin tube.

In an embodiment of the present invention, the heating unit may further include: a sensor unit including a first sensor disposed at the downstream side from the preheating unit and a second sensor disposed at the downstream side from the firing unit, in which the sensor unit may measure the temperature of the heated fin tube.

In an embodiment of the present invention, the heating unit may further include a control unit connected with the heating module, and the control unit may control the heating module such that the fin tube is heated at a predetermined temperature when the temperature of the fin tube measured by the sensor unit is out of the predetermined temperature.

In an embodiment of the present invention, the control unit may be further connected with the conveying unit that conveys the fin tube, and when the temperature of the fin tube measured by the first sensor is lower than the predetermined temperature, the control unit may load the fin tube again into the heating chamber by reversing the rollers of the conveying unit such that the fin tube reaches the predetermined temperature.

In an embodiment of the present invention, the glaze powder may be pure frit.

The configuration of the present invention for achieving the objects provides a heating method of a high-frequency induction heating unit, the method including: a) preheating the fin tube; and b) applying the glaze powder to the preheated fin tube and then firing the fin tube applied with the glaze powder, in which the fin tube is induction-heated in accordance with movement in a high-frequency magnetic field in the steps a) and b).

In an embodiment of the present invention, the fin tube may be heated at 800° C. to 860° C. in the steps a) and b).

In an embodiment of the present invention, in the step a), the preheating temperature of the fin tube may be determined to correspond to the thickness of an enamel coating layer to be formed on the fin tube, and the higher the preheating temperature, the thicker the enamel coating layer.

The configuration of the present invention for achieving the objects provides a non-interrupting dry type pure frit applying unit that is used for an enamel coating device for a fin tube, the applying unit including: an applying chamber unit through which the fin tube passes; and a spraying unit disposed over the applying chamber unit and applying glaze powder to the heated fin tube.

In an embodiment of the present disclosure, the glaze powder that is sprayed by the spraying unit may be pure frit.

In an embodiment of the present disclosure, the applying unit may further include a restoring unit restoring and moving remaining glaze powder not coated on the fin tube of the glaze powder applied from the spraying unit to the spraying unit.

In an embodiment of the present disclosure, the restoring unit may include: a collection container disposed under the applying chamber unit and collecting the remaining glaze powder; and a pump moving the remaining glaze powder collected in the collection container to the spraying unit.

In an embodiment of the present disclosure, the spraying unit receives the glaze powder from the storing unit that stores the glaze powder.

In an embodiment of the present disclosure, a discharging unit disposed at a side of the applying chamber unit and discharging air in the applying chamber unit may be further included.

In an embodiment of the present disclosure, the discharging unit may include: a discharge body provided in a tube shape at a side of the applying chamber unit; and a filter disposed in the discharge body, and the filter may restore fine glaze powder and noxious substances included in air that is produced and discharged when the glaze powder is coated on the fin tube for enamel coating.

In an embodiment of the present disclosure, the discharging unit may further include a scrubber restoring again the surplus fine glaze powder and noxious substances included in the air discharged from the discharge body.

In an embodiment of the present disclosure, the applying chamber unit may have an air curtain formed at an outlet that the fin tube passes, and the air curtain may prevent the glaze powder from leaking out of the applying chamber unit through the outlet.

In an embodiment of the present disclosure, the applying chamber unit is made of a material having heat resistance not to be damaged by the heated fin tube.

The configuration of the present invention for achieving the object provides an applying method of a non-interrupting dry type pure frit applying unit that is used for an enamel coating device for a fin tube, the method including: a) loading the fin tube into the applying chamber unit; and b) applying the glaze powder to the heated fin tube by means of the spraying unit, in which, in the step b), the glaze powder is pure frit.

In an embodiment of the present disclosure, the method may further include c) restoring and moving remaining glaze powder not coated on the fin tube of the glaze powder applied from the spraying unit to the spraying unit after the step b).

### Advantageous Effects of Invention

According to the present invention having the above configuration, since a fin tube is coated with enamel by applying glaze powder that is solid powder-state pure frit, acid resistance of the fin tube is improved.

Further, some of the glaze powder is thermally bonded to the fin tube preheated by the preheating unit and others are attached to the surface of the fin tube in a powder state. Further, the others are completely thermally bonded when it is loaded into the firing unit, thereby making very firm enamel coating.

Further, the preheating unit burns oil or other impurities on the surface of the fin tube and an enamel layer is formed only by fine particles by the pure frit, so acid resistance is improved and the surface is made smooth. Further, limestone-based substances are not attached, so higher performance than existing enamel structure can be achieved.

Further, since the preheating unit, the applying unit, and the firing unit are not equipped with rollers, it is possible to prevent an enamel coating layer from coming off due to friction between a roller and the outer side of the fin tube not finished being fired.

Further, since the heating unit heats the fin tube that is being rotated using high-frequency induction heating, a heat loss is small and a heat difference is also small, as compared with an electric heating type of the related art.

Further, the fin tube is improved in elongation through heat treating twice by the preheating unit and the firing unit.

Further, since an air curtain is provided at the outlet of the applying unit, it is possible to prevent the glaze powder applied in the applying unit from discharging with the fin tube through the outlet.

Further, since the restoring unit in the applying unit enables the applied glaze powder not thermally bonded to the fin tube to be reused, it is economical.

The effects of the present invention are not limited thereto and it should be understood that the effects include all effects that can be inferred from the configuration of the present invention described in the following specification or claims.

### BRIEF DESCRIPTION OF DRAWINGS

FIG. 1 is an exemplary side view of an enamel coating device for a fin tube according to an embodiment of the present invention.

FIG. 2 is an exemplary plan view showing a conveying unit of an enamel coating device for a fin tube according to an embodiment of the present invention.

FIG. 3 is an exemplary view of an enamel coating device for a fin tube according to an embodiment of the present invention.

FIG. 4 is an exemplary view showing a heating chamber of an enamel coating device for a fin tube according to an embodiment of the present invention.

FIG. 5 is an exemplary view showing an applying unit of an enamel coating device for a fin tube according to an embodiment of the present invention.

FIG. 6A is a picture showing a fin tube before it is coated with enamel by an enamel coating device for a fin tube according to an embodiment of the present invention.

FIG. 6B is a picture showing a fin tube coated with enamel by an enamel coating device for a fin tube according to an embodiment of the present invention.

FIG. 7 is a flowchart of an enamel coating method for a fin tube according to an embodiment of the present invention.

### DESCRIPTION OF EMBODIMENTS

The more preferable embodiment of the present invention provides an enamel coating device for a fin tube that includes: a conveying unit that conveys a fin tube having a hollow tube and a fin spirally formed on the outer side of the tube; an applying unit that applies glaze powder to the fin tubes loaded by the conveying unit; and heating units that are disposed at both sides of the applying unit to heat the fin tubes, in which the glaze powder is pure frit.

### Examples

Hereinafter, the present invention is described with reference to the accompanying drawings. However, the present invention may be modified in various different ways and is not limited to the embodiments described herein. Further, in the accompanying drawings, components irrelevant to the description will be omitted in order to obviously describe the present invention, and similar reference numerals will be used to describe similar components throughout the specification.

Throughout the specification, when an element is referred to as being “connected with (coupled to, combined with, in contact with)” another element, it may be “directly connected” to the other element and may also be “indirectly connected” to the other element with another element intervening therebetween. Further, unless explicitly described otherwise, “comprising” any components will be understood to imply the inclusion of other components rather than the exclusion of any other components.

Terms used in the present invention are used only in order to describe specific exemplary embodiments rather than limiting the present invention. Singular forms are intended to include plural forms unless the context clearly indicates otherwise. It will be further understood that the terms “comprise” or “have” used in this specification specify the presence of stated features, steps, operations, components, parts, or a combination thereof, but do not preclude the presence or addition of one or more other features, numerals, steps, operations, components, parts, or a combination thereof.

Hereinafter, embodiments are described in detail with reference to the accompanying drawings.

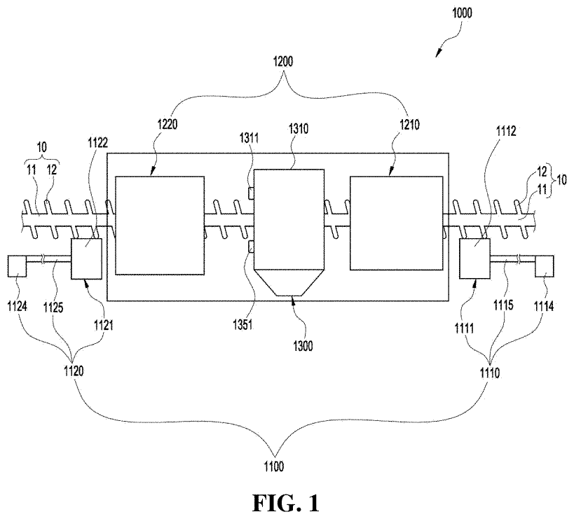

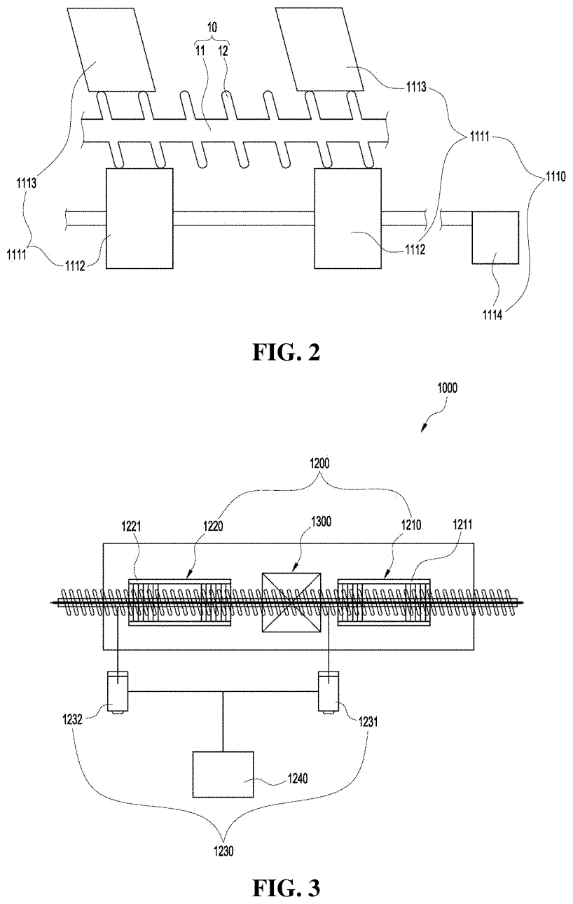

FIG. 1 is an exemplary side view of an enamel coating device for a fin tube according to an embodiment of the present invention, and FIG. 2 is an exemplary plan view showing a conveying unit of an enamel coating device for a fin tube according to an embodiment of the present invention.

As shown in FIGS. 1 and 2, an enamel coating device 1000 for a fin tube includes a conveying unit 1100, heating units 1200, and an applying unit 1300. The conveying unit 1100 is provided to convey a fin tube 10, the heating units 1200 are disposed at both sides of the applying unit 1300 to heat the fin tube 10 and includes a preheating unit 1210 and a firing unit 1220. The applying unit 1300 is provided to apply glaze powder to the fin tube 10 loaded by the conveying unit 1100. The fin tube 10 has a hollow tube 11 and a fin 12 spirally formed on the outer side of the tube 11.

Hereinafter, the parts of the enamel coating device 1000 for a fin tube is described in more detail.

First, the conveying unit 1100 includes a feeder unit 1110 and an unfeeder unit 1120.

The feeder unit 1110 can load the fin tube 10 to the preheating unit 1210 and includes a roller 1111, a motor 1114, and a rotary shaft 1115.

The roller 1111 includes a first wheel 1112 and a second wheel 1113, and the first wheel 1112 and the second wheel 1113 can support in pair the fin tube 10 placed thereon. A plurality of rollers 1111 may be provided.

The rotary shaft 1115 may be disposed to connect the first wheels 1112 through the center of the first wheels 1112.

The motor 1114 can provide rotational power to the first wheel 1112 by rotating the rotary shaft 1115.

In more detail, the first wheel 1112 can move the fin tube 10 forward and backward, depending on the rotational direction of the rotary shaft 1115 by the motor 1114, by rotating in contact with the outer side of the fin 12. For example, when the motor 1114 rotates the rotary shaft 1115 clockwise, the first wheel 1112 rotates counterclockwise and moves forward the fin tube 10 having the spiral fin 12. On the contrary, when the first wheel 1112 is rotated counterclockwise by the motor 1114, the fin tube 10 can be rotated clockwise and moved backward.

The second wheel 1113 is provided to support the fin tube 10 in contact with the outer side of the fin tube 10 such that the fin tube 10 can be rotated, and may extend in the forming direction of the fin 12 spirally formed, as shown in FIG. 2. The second wheel 1113 provided in this way can prevent the fin tube 10 from idling or separating from the roller 1111.

The rollers 1111 may be characterized by being provided such that the gap of an adjacent pair is adjusted in correspondence to the diameter of the fin tube 10. In detail, the roller 1111 can change the gap between the pair of first wheel 1112 and second wheel 1113 in accordance with the diameter of the fin tube 10. Accordingly, the enamel coating device 1000 for a fin tube can adjust the gap between the first wheel 1112 and the second wheel 1113 to correspond to various kinds of fin tubes having various diameters of 38 mm to 75 mm, so it can efficiently and economically perform enamel coating on the fin tube 10 having various diameters.

The unfeeder unit 1120 may be provided to restore the fin tube 10 that has passed through the firing unit 1220. The unfeeder unit 1120 is disposed at the downstream side from the firing unit 1220 and includes a roller 1121, a motor 1124, and a rotary shaft 1125 to move forward and backward the fin tube 10 that has passed through the firing unit 1220. The roller 1121 includes a first wheel 1122 and a second wheel (not shown). The detailed configuration of the unfeeder unit 1120 is substantially the same as the detailed configuration of the feeder unit 1110, so the unfeeder unit 1120 is not described in detail.

Meanwhile, the gap between the roller 1111 of the feeder unit 1110 disposed at the inlet of the preheating unit 1210 and the roller 1121 of the unfeeder unit 1120 disposed at the outlet of the firing unit 1220 is between 1 m to 1.2 m, so it is possible to prevent sagging of the fin tube 10 disposed at the heating unit 1200 and the applying unit 1300.

In more detail, the heated fin tube 10 relatively decreases in rigidity while passing through the heating unit 1200 at high temperature. Accordingly, when the gap between the roller 1111 of the feeder unit 1110 supporting the bottom of the fin tube 10 and the roller 1121 of the unfeeder unit 1120 exceeds 1.2 m, the fin tube 10 may sag and bend. Accordingly, it is preferable to maintain the gap between the roller 1111 of the feeder unit 1110 and the roller 1121 of the unfeeder unit 1120 at 1.2 m or less in order to enable the heating unit 1200 and the applying unit 1300 to be disposed and prevent the fin tube 10 from sagging.

Further, since there is no roller at the heating unit 1200 and the applying unit 1300, it is also possible to prevent an enamel coating layer from coming off due to friction between a roller and the outer side of the fin tube 10 not finished being fired.

The feeder unit 1110 may further include a loader (not shown) that provides the fin tube 10 onto the roller 1111, and the unfeeder unit 1120 may further include an unloader (not shown) that restores the fin tube 10 on the roller 1111.

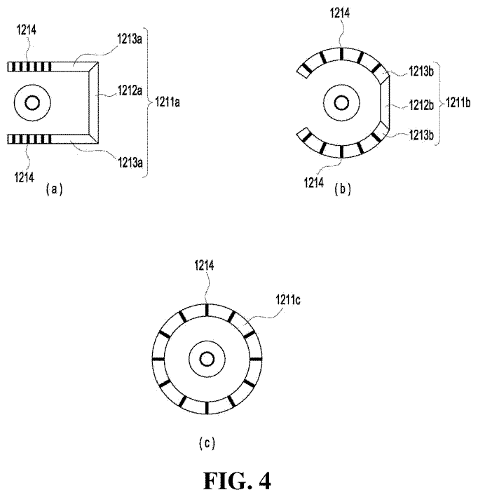

FIG. 3 is an exemplary view of an enamel coating device for a fin tube according to an embodiment of the present invention, and FIG. 4 is an exemplary view showing a heating chamber of an enamel coating device for a fin tube according to an embodiment of the present invention.

As shown in FIGS. 3 and 4, the heating unit 1200 includes the preheating unit 1210 and the firing unit 1220.

The preheating unit 1210 is disposed at a side of the applying unit 1300 and can heat the fin tube 10 loaded by the conveying unit 1100. The firing unit 1220 is disposed at the other side of the applying unit 1300 and can heat the fin tube 10 applied with the glaze powder.

The applying unit 1300 and the preheating unit 1210 are spaced by a predetermined first gap, and the applying unit 1300 and the firing unit 1220 are spaced by a predetermined second gap, in which the first gap may be characterized by being smaller than the second gap. In detail, when the fin tube 10 is loaded into the applying unit 1300 through the preheating unit 1210, it has had to be heated at temperature of 800° C. to 860° C. for high-quality enamel coating. That is, the fin tube 10 that has passed through the preheating unit 1210 should be quickly loaded into the applying unit 1300 before it is cooled by air. Accordingly, the first gap is smaller than the second gap so that the fin tube 10 that has passed through the preheating unit 1210 can be quickly loaded into the applying unit 1300. To this end, preferably, the first gap may be characterized by being 0.04 to 0.06 m and the second gap may be characterized by being 0.09 to 0.11 m. Further, the distance from the end of the preheating unit 1210 to the end of the firing unit 1220 may be within 1.2 m.

Further, the preheating unit 1210 and the firing unit 1220 can perform induction heating in accordance with movement of the fin tube 10 in a high-frequency magnetic field. In detail, high-frequency induction heating uses the principle that when a magnetic field applied to a metallic conductor in a magnetic field is changed, an eddy current interfering with the change of the magnetic field is generated. The eddy current, which is a current against a change in magnetic field, interferes with movement of the metallic conductor that is moved in a magnetic field. When the eddy current is lost, the metallic conductor is heated.

Since the heating unit 1200 heats the fin tube 10 through high-frequency induction heating in the principle described above, there is an advantage of a small heat loss and heat difference in comparison to the electric heating type of the related art. In detail, the heating unit 1200 heats first the inside of the fin tube 10 that is moved with rotation, so there is a small heat difference and the coupling structure of enamel coating is further hardened. Further, the eddy current is generated only when a magnetic field is changed by movement of the metallic conductor in the magnetic field. Accordingly, the fin tube 10 is heated with rotation only when the fin tube 10 is positioned in the preheating unit 1210 or the firing unit 1220, and otherwise, power is not used. As a result, the operation energy and cost of the heating unit 1200 are reduced, and stable and efficient operation is possible.

The heating unit 1200 can heat the fin tube 10 at 800° C. to 860° C.

In detail, the preheating unit 1210 may include a heating chamber 1211 and a heating module 1214.

FIG. 4A is an exemplary view showing a heating chamber according to a first embodiment.

As show in FIG. 4A, a heating chamber 1211a according to the first embodiment forms the body of the preheating unit 1210 and includes a first vertical frame 1212a and first horizontal frames 1213a.

The first vertical frame 1212a is disposed at a side of the fin tube 10 and may vertically extend from the ground. The first horizontal frames 1213a may extend in parallel toward the upper portion and the lower portion of the fin tube 10 from the upper end and the lower end of the first vertical frame 1212a.

FIG. 4B is an exemplary view showing a heating chamber according to a second embodiment.

As show in FIG. 4B, a heating chamber 1211b according to the first embodiment forms the body of the preheating unit 1210 and includes a second vertical frame 1212b and second horizontal frames 1213b.

The second vertical frame 1212b is disposed at a side of the fin tube 10 and may vertically extend from the ground. The second horizontal frames 1213b may extend toward the upper portion and the lower portion of the fin tube 10 from the upper end and the lower end of the second vertical frame 1212b. Further, the second horizontal frames 1213b may bend and extend with a curvature corresponding to the circumference of the fin tube 10 in accordance with the size of the fin tube 10. The second vertical frame 1212b such provided can reduce a heat difference for the fin tube 10 and can increase thermal efficiency by reducing heat leaking outside.

FIG. 4C is an exemplary view showing a heating chamber according to a third embodiment.

As shown in FIG. 4C, a heating chamber 1211c according to the third embodiment may be characterized by being formed in a tube shape in which the fin tube 10 can be received. The heating chamber 1211c such provided can improve thermal efficiency by further preventing the heat applied to the fin tube 10 from leaking outside.

The heating module 1214 may be disposed in the heating chambers 1211a, 1211b, and 1213c disclosed in the first to third embodiments. The heating module 1213 such provided can generate a high-frequency magnetic field so that the fin tube 10 can be induction-heated when it is moved in the high-frequency magnetic field.

The firing unit 1220 can perform firing heating on the fin tube 10 coated with enamel through the applying unit 1200. The firing unit 1220 includes the heating chamber 1221 and a heating module (not shown). The heating chamber 1221 and the heating module of the firing unit 1220 are substantially the same as the configuration of the preheating unit 1210, so the same configuration is not described.

The firing unit 1220 can completely thermally bond glaze powder attached to the surface of the fin tube 10 in a powder state to the fin tube 10. In detail, when the glaze powder is applied to the fin tube 10, some is immediately thermally bonded to the fin tube 10, but others are attached in powder state to the surface of the fin tube 10. Accordingly, the firing unit 1220 can completely thermally bond the glaze powder attached in a powder state to the surface of the fin tube 10 to the fin tube 10 for firm enamel coating.

The heating unit 1200 may further include a sensor unit 1230 and a control unit 1240.

The sensor unit 1230 includes a first sensor 1231 disposed at the downstream side from the preheating unit 1210 and a second sensor 1232 disposed at the downstream side from the firing unit 1220, and can measure the temperature of the heated fin tube 10. However, the position of the sensor unit 1230 is not limited to an embodiment. Further, as long as the first sensor 1231 is at a position where it can measure the temperature of the fin tube 10 that has passed through the preheating unit 1210 and the second sensor 1232 is at a position where it can measure the temperature of the fin tube 10 that has passed through the firing unit 1220, any configuration can be included in an embodiment.

When the temperature of the fin tube 10 measured by the sensor unit 1230 is out of a predetermined temperature, the control unit 1240 can control the heating module 1214 of the preheating unit 1210 and the heating module of the firing unit 1220 such that the fin tube 10 is heated at the predetermined temperature.

For example, when the temperature of the fin tube 10 measured by the first sensor 1231 is less than 800° C., the control unit 1240 can increase the intensity of the magnetic field of the heating module 1214 to increase the temperature of the fin tube 10. Further, when the temperature of the fin tube 10 measured by the first sensor 1231 exceeds 850° C., the control unit 1240 can decrease the intensity of the magnetic field of the heating module 1214 to decrease the temperature of the fin tube 10.

The control unit 1240 may be further connected with the conveying unit 1100. When the temperature of the fin tube 10 measured by the first sensor 1231 is lower than the predetermined temperature, the control unit 1240 may be characterized by loading the fin tube 10 again into the preheating unit 1211 by reversing the roller 1111 using the motor 1114 of the feeder unit 1100 such that the fin tube 10 reaches the predetermined temperature. For example, when the temperature of the fin tube 10 measured by the first sensor 1231 is less than 800° C., the control unit 1240 can load the fin tube 10 again into the heating chamber 1211 by reversing the roller 1111. When the fin tube 10 reaches 800° C. or more, the control unit 1240 can load the fin tube 10 into the applying unit 1300 by reversing again the roller 1111.

When the temperature of the fin tube 10 becomes 800° C. or more, the control unit 1240 loads the fin tube into the applying unit 1300, thereby being able to coat the fin tube 10 with enamel at an optimal temperature by the glaze powder.

Further, as described above, the fin tube 10 can be improved in elongation by being heated twice by the preheating unit 1210 and the firing unit 1220.

TABLE 1

| Fin tube heating step | Fin tube | Elongation (%) |
|---|---|---|
| Before passing through | Experiment Example 1 | 32 |
| preheating unit | Experiment Example 2 | 28 |
| | Experiment Example 3 | 32 |
| After passing through | Experiment Example 4 | 37 |
| preheating unit | Experiment Example 5 | 36 |
| | Experiment Example 6 | 34 |
| After passing through firing | Experiment Example 7 | 37 |
| unit | Experiment Example 8 | 38 |
| | Experiment Example 9 | 37 |

Table 1 shows elongation according to steps of heating of the fin tube 10. In detail, Experiment Examples 1 to 3 are the fin tubes 10 that did not pass the preheating unit 1210 yet, and it can be seen that the elongation of the fin tube 10 is 28% to 32%.

Experiment Examples 4 to 6 are the fin tubes 10 that passed the preheating unit 1210, and it can be seen that the elongation of the fin tube 10 increased to 34% to 37%.

Experiment Examples 7 to are the fin tubes 10 that passed the firing unit 1220, and it can be seen that the elongation of the fin tube 10 increased to 37% to 38%.

As can be seen from Table 1, the fin tube 10 can increase in elongation by passing through the preheating unit 1210 and the firing unit 1220.

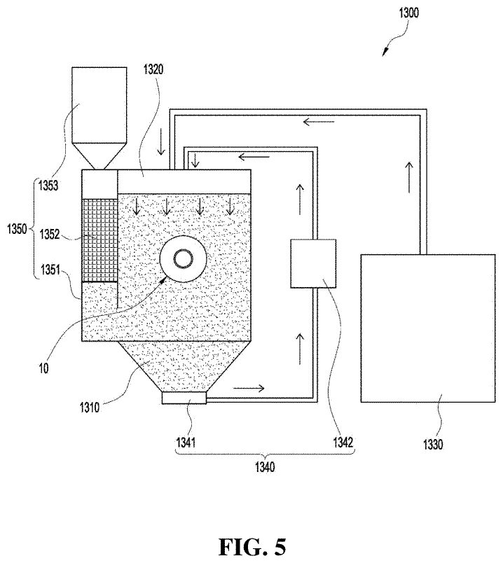

FIG. 5 is an exemplary view showing an applying unit of an enamel coating device for a fin tube according to an embodiment of the present invention.

Referring to FIGS. 1 and 5, the applying unit 1300 can apply the glaze powder to the fin tube 10 and includes an applying chamber unit 1310 and a spraying unit 1320.

The applying chamber unit 1310 is provided such that the fin tube 10 can pass through it, and configures a body forming the outer shape of the applying unit 1300. The applying chamber unit 1310 may be made of a material having heat resistance not to be damaged by the heated fin tube 10. In detail, the fin tube 10 is at a high temperature of 800° C. to 860° C. when it is loaded into the applying chamber unit 1310. Accordingly, it is preferable that the applying chamber unit 1310 is made of a material having heat resistance such that it is not damaged at a temperature under at least 860° C.

As shown in FIG. 1, the applying chamber unit 1310 may have an air curtain 1311 at the outlet that the fin tube 10 passes through. The air curtain 1351 can prevent the glaze power from leaking out of the applying chamber unit 1310 through the outlet.

In detail, the fin tube 10 is loaded into the inlet of the applying chamber unit 1310 and then passes through the outlet. The glaze powder existing in the applying chamber unit 1310 can be discharged with the fin tube 10 through the outlet of the applying chamber unit 1310 when the fin tube 10 passes through the outlet of the applying chamber unit 1310. Accordingly, since the air curtain 1351 is disposed at the outlet of the applying chamber unit 1310, it can prevent the glaze powder from leaking out through the outlet of the applying chamber unit 1310.

Meanwhile, since fin tubes 10 are continuously loaded into the inlet of the applying chamber unit 1310, airflow is generated toward the inside from the outside of the applying chamber unit 1310. That is, since the glaze powder in the applying chamber unit 1310 is not discharged outside through the inlet, it is preferable not to install the air curtain 1351 at the inlet of the applying chamber unit 1310.

Further, when the air curtain 1351 is installed at the inlet of the applying chamber unit 1310, the temperature of the heated fin tube 10 may decrease, so it is preferable not to install the air curtain 1351 at the inlet of the applying chamber unit 1310.

The spraying unit 1320 is installed over the applying chamber unit 1310 and can apply the glaze powder to the heated fin tube 10. The glaze powder may be characterized by being pure frit. In detail, the glaze powder is solid powder composed of pure frit and does not contain any additives for enamel such as clay or other oxides. The applying unit coats the fin tube 10 with enamel by applying glaze powder that is solid powder-state pure frit, as described above, so acid resistance of the fin tube 10 can be improved.

When the pure frit glaze powder is thermally coated on the heated fin tube 10 for enamel coating, impurities and the like on the surface of the fin tube have been removed already by high temperature of 800° C. to 860° C. through the preheating unit 1210. Accordingly, the acid resistance of the fin tube 10 coated with enamel is further improved and the surface can be made smooth.

The spraying unit 1320 is not necessarily installed over the applying chamber unit 1310 and may be installed on a side of the applying chamber unit 1310. That is, the spraying unit 1320 can be installed at a position where it can uniformly apply the pure frit glaze powder to the fin tube 10.

The thickness of the enamel coating layer on the fin tube 10 may depend on the preheating temperature of the fin tube 10. In detail, the higher the temperature when the fin tube 10 is loaded in the applying chamber unit 1310, the thicker the enamel coating layer on the fin tube 10. On the contrary, the lower the temperature when the fin tube 10 is loaded in the applying chamber unit 1310, the thinner the enamel coating layer on the fin tube 10.

The applying unit 1300 may further include a storing unit 1330, a restoring unit 1340, and a discharging unit 1350.

First, the storing unit 1330 can store the pure frit glaze powder and can provide the stored pure frit glaze powder to the spraying unit 1320. The storing unit 1330 may be disposed at a side of or over the applying chamber unit 1310, but is not limited thereto and may be disposed at any position as long as it can easily supply the pure frit glaze powder to the spraying unit 1320.

The restoring unit 1340 may be provided to restore remaining glaze powder not coated on the fin tube 10 of the pure frit glaze powder applied from the spraying unit 1320 and move it to the spraying unit 1320. The restoring unit 1340 includes a collection container 1341 and a pump 1342.

The collection container 1341 is disposed under the applying chamber unit 1310 and can collect the remaining glaze powder. In detail, when the spraying unit 1320 applies the pure frit glaze powder to the heated fin tube 10, some of the applied pure frit glaze powder is thermally bonded to the fin tube 10, so it can be used as the material for enamel coating. However, the remaining pure frit glaze powder not thermally bonded to the fin tube 10 is accumulated under the applying chamber unit 1310. Accordingly, the collection container 1341 can collect the remaining glaze powder that is accumulated on the ground under the applying chamber unit 1310. Further, as shown in FIG. 5, the applying chamber unit 1310 may have an inverse trapezoidal lower portion so that the remaining glaze powder can be collected well in the collection container 1341.

The pump 1342 can move the remaining glaze powder collected in the collection container 1341 to the spraying unit 1320. In detail, when the remaining glaze powder not used for enamel coating is accumulated under the applying chamber unit 1310, there is a troublesome that it is required to periodically open and clean the applying chamber unit 1310. Further, there is a problem that the enamel coating device 1000 for a fin tube should be stopped while the remaining glaze powder is removed. However, since the pump 1342 continuously moves the remaining glaze powder collected in the collection container 1341 to the spraying unit 1320, the sprayed remaining glaze powder can be reused. Thus, economical enamel coating is possible by increasing the operation time of the enamel coating device 1000 for a fin tube.

The pump 1342 can also provide the remaining glaze powder collected in the collection container 1341 to the storing unit 1330.

A separate control module (not shown) operating the restoring unit 1340 and the storing unit 1330 together may be provided. The control module such provided can control the amount of pure frit glaze powder that is provided to the spraying unit 1320 from the storing unit 1330 in accordance with the amount of remaining glaze powder that is provided to the spraying unit 1320 from the restoring unit 1340.

The discharging unit 1350 is disposed at a side of the applying chamber unit 1310 and can discharge the air in the applying chamber unit 1310. The discharging unit 1350 may include a discharge body 1351, a filter 1352, and a scrubber 1353.

The discharge body 1351 is provided in a tube shape at a side of the applying chamber unit 1310. In detail, the discharge body 1351 may be disposed at a side of the applying chamber unit, extending upward. Fine glaze powder and noxious substances included in the air, which is produced and discharged when the pure frit glaze powder is coated on the fin tube 10 for enamel coating, can be discharged through the inside of the discharge body 1351.

The filter 1352 is disposed in the discharge body 1351. The filter 1352 can restore the fine glaze powder and noxious substances included in the air that is discharged outside through the discharge body 1351.

The scrubber 1353 can restore again the surplus fine glaze powder and noxious substances included in the air discharged from the discharge body 1351. That is, the scrubber 1353 can enable the enamel coating device 1000 for a fin tube to operate safely by restoring the fine glaze powder and noxious substances not restored through the filter 1352.

The enamel coating device 1000 for a fin tube configured as described above does not need an additional device for uniformly applying the pure frit glaze powder such as a brush. Further, since the enamel coating device 1000 for a fin tube uses solid-state pure frit glaze powder, there is no need for a drying device for drying liquid-state enamel glaze of the related art, so the device can more economically and quickly perform the process and occupies a smaller installation area.

Further, the enamel coating device 1000 for a fin tube was designed to perform all processes for heating within a minimum distance range where thermal deformation can be generated in spite of the small length of the facility. Further, the glaze powder that is used herein is not only pure frit, but has small particles and does not contain water, so non-processing of the end of the fin tube 10 or pin-holes on the surface can be minimized and attachment of limestone-based substances that are generated in the use environment can also be minimized.

Further, the enamel coating device 1000 for a fin tube perform heat treatment at not a common temperature of 500-550° C., but at 800° C. or more of the preheating unit 1210, and then attach the pure frit using the heat. Accordingly, it is also possible to achieve an effect that an enamel layer of a tube is more firmly thermally bonded than the fin as a plan against a defect such as scale or chipping of the enamel surface due to a gush of gas that may occur in a structure without the inside of the fin tube 10 coated with enamel.

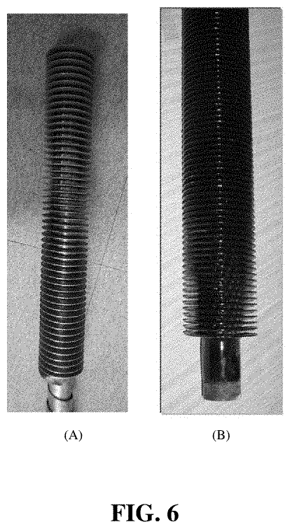

FIG. 6A is a picture showing a fin tube before it is coated with enamel by an enamel coating device for a fin tube according to an embodiment of the present invention, and FIG. 6B is a picture showing a fin tube coated with enamel by an enamel coating device for a fin tube according to an embodiment of the present invention.

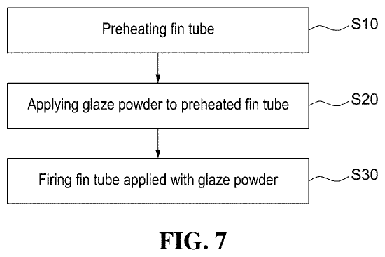

FIG. 7 is a flowchart of an enamel coating method for a fin tube according to an embodiment of the present invention.

As shown in FIG. 7, an enamel coating method for a fin tube can perform first preheating the fin tube 10 (S10). In this step, the fin tube 10 can be preheated by high-frequency induction heating at 800° C. to 860° C., in which the preheating can be performed to correspond to the thickness of the enamel coating layer to be formed on the fin tube 10. In more detail, the higher the temperature of the fin tube 10, the thicker the enamel coating layer is formed when the glaze powder is applied. Accordingly, the preheating temperature of the fin tube 10 can be determined in consideration of the thickness of the enamel coating layer to be formed on the fin tube 10. Further, in the step S10 of preheating the fin tube 10, enamel can be coated better by burning up the foreign substances such as oil on the surface of the fin tube 10.

Next, applying the glaze powder to the preheated fin tube 10 (S20) may be performed. The glaze powder may be characterized by being pure frit.

Next, firing the fin tube 10 applied with the glaze powder (S30) may be performed. In detail, when the glaze powder is applied to the fin tube 10 that has been preheated, the fin tube 10 may pass through the applying unit 1300 with only some of the glaze powder, which has been attached to the fin tube 10, thermally bonded and others not thermally bonded, but attached to the fin tube 10. Accordingly, in the firing of the fin tube 10 applied with the glaze powder (S30), it is possible to make the enamel coating more firmly by completely thermally bonding the glaze powder, which is not thermally bonded, but attached to the fin tube 10, to the fin tube 10. Further, even in this step, the fin tube 10 can be preheated by high-frequency induction heating.

The above description is provided as an exemplary embodiment of the present invention and it should be understood that the present invention may be easily modified in other various ways without changing the spirit or the necessary features of the present invention by those skilled in the art. Therefore, the embodiments described above are only examples and should not be construed as being limitative in all respects. For example, the components described as a single part may be divided and the components described as separate parts may be integrated.

### REFERENCE SIGNS LIST

10: Fin tube
11: Tube
12: Fin
1000: Enamel coating device for fin tube
1100: Conveying unit
1110: Feeder unit
1111: Roller
1112: First wheel
1113: Second wheel
1114: Motor
1115: Rotary shaft
1120: Unfeeder unit
1121: Roller
1122: First wheel
1124: Motor
1125: Rotary shaft
1200: Heating unit
1210: Preheating unit
1211: Heating chamber
1211a: First heating chamber
1211b: Second heating chamber
1211c: Third heating chamber
1212a: First vertical frame
1212b: Second vertical frame
1213a: First horizontal frame
1213b: Second horizontal frame
1214: Heating module
1220: Firing unit
1221: Heating chamber
1230: Sensor unit
1231: First sensor
1232: Second sensor
1240: Control unit
1300: Applying unit
1310: Applying chamber unit
1311: Air curtain
1320: Spraying unit
1330: Storing unit
1340: Restoring unit
1341: Collection container
1342: Pump
1350: Discharging unit
1351: Discharge body
1352: Filter
1353: Scrubber

1. An enamel coating device for a fin tube, comprising:
a conveying unit that conveys a fin tube having a hollow tube and a fin spirally formed on the outer side of the tubes;
an applying unit that applies glaze powder to the fin tubes loaded by the conveying unit; and
heating units that are disposed at both sides of the applying unit to heat the fin tubes, in which the glaze powder is pure frit.

2. The enamel coating device of claim 1, wherein the heating unit includes:
a preheating unit disposed at a side of the applying unit and heating the fin tube loaded by the conveying unit; and
a firing unit disposed at the other side of the applying unit and heating the fin tube applied with the glaze powder, and
the preheating unit and the firing unit heat the fin tube at 800° C. to 860° C. through induction heating according to movement of the fin tube in a high-frequency magnetic field.

3. The enamel coating device of claim 2, wherein the applying unit and the preheating unit are spaced by a predetermined first gap, the applying unit and the firing unit are spaced by a predetermined second gap, and the first gap and the second gap are different.

4. The enamel coating device of claim 2, wherein the conveying unit includes:
a feeder unit loading the fin tube into the preheating unit; and
an unfeeder unit restoring the fin tube that has passed through the firing unit.

5. The enamel coating device of claim 4, wherein the feeder unit and the unfeeder unit include:
a plurality of rollers including pairs of a first wheel and a second wheel on which the fin tube is placed;
a rotary shaft disposed to connect the first wheels through the center of the first wheels; and
a motor providing rotational power to the rotary shaft, and
the first wheels move the fin tube forward and backward in accordance with the rotational direction of the rotary shaft by rotating in contact with the outer side of the fin.

6. The enamel coating device of claim 5, wherein the second wheels rotatably support the fin tube and extend in the forming direction of the fin spirally formed, and the rollers are provided such that the gap of an adjacent pair is adjusted in correspondence to the diameter of the fin tube.

7. The enamel coating device of claim 2, wherein the preheating unit and the firing unit include:
a heating module generating a high-frequency magnetic field for induction heating in accordance with movement of the fin tube in the high-frequency magnetic field; and
a heating chamber accommodating the heating module and forming a body.

8. The enamel coating device of claim 7, wherein the heating chamber includes:
a first vertical frame disposed at a side of the fin tube and vertically extending from the ground; and
first horizontal frames extending in parallel toward the upper portion and the lower portion of the fin tube from the upper end and the lower end of the first vertical frame.

9. The enamel coating device of claim 7, wherein the heating chamber includes:
a second vertical frame disposed at a side of the fin tube and vertically extending from the ground; and
second horizontal frames extending toward the upper portion and the lower portion of the fin tube from the upper end and the lower end of the second vertical frame and bending and extending with a curvature corresponding to the circumference of the fin tube in accordance with the size of the fin tube.

10. The enamel coating device of claim 7, wherein the heating unit further includes a sensor unit including a first sensor disposed at the downstream side from the preheating unit and a second sensor disposed at the downstream side from the firing unit, and a control unit connected with the heating module, and
the control unit controls the heating module such that the fin tube is heated at a predetermined temperature when the temperature of the fin tube measured by the sensor unit is out of the predetermined temperature.

11. The enamel coating device of claim 10, wherein the control unit is further connected with the conveying unit that conveys the fin tube, and
when the temperature of the fin tube measured by the first sensor is lower than the predetermined temperature, the control unit loads the fin tube again into the heating chamber by reversing the rollers of the conveying unit such that the fin tube reaches the predetermined temperature.

12. The enamel coating device of claim 1, wherein the applying unit includes:
an applying chamber unit through which the fin tube passes; and
a spraying unit disposed over the applying chamber unit and applying glaze powder to the heated fin tube, and
the glaze powder that is sprayed by the spraying unit is pure frit.

13. The enamel coating device of claim 12, wherein the applying unit further includes a restoring unit restoring and moving remaining glaze powder not coated on the fin tube of the glaze powder applied from the spraying unit to the spraying unit, and
the restoring unit includes:
a collection container disposed under the applying chamber unit and collecting the remaining glaze powder; and
a pump moving the remaining glaze powder collected in the collection container to the spraying unit.

14. The enamel coating device of claim 12, further comprising a discharging unit disposed at a side of the applying chamber unit and discharging air in the applying chamber unit,
the discharging unit includes:
a discharge chamber provided in a tube shape at a side of the applying chamber unit; and
a filter disposed in the discharge body, and
the filter restores fine glaze powder and noxious substances included in air that is produced and discharged when the glaze powder is coated on the fin tube for enamel coating.

15. The enamel coating device of claim 12, wherein the discharging unit further includes a scrubber restoring again the surplus fine glaze powder and noxious substances included in the air discharged from the discharge body.

16. The enamel coating device of claim 12, wherein the applying chamber unit has an air curtain formed at an outlet that the fin tube passes, and
the air curtain prevents the glaze powder from leaking out of the applying chamber unit through the outlet.

17. A coating method using the enamel coating device for a fin tube of claim 1, the method comprising:
a) preheating the fin tube;
b) applying the glaze powder to the preheated fin tube; and
c) firing the fin tube applied with the glaze powder,
wherein in the step b), the glaze powder is pure frit in the applying of the glaze powder.
